(19) United States
(12) Patent Application Publication
(10) Pub. No.: US 2017/0282429 A1
(43) Pub. Date: Oct. 5, 2017

(54) DEVICE AND METHOD FOR MOULDING MICRO-COMPONENTS

(71) Applicant: SOPROD SA, Sion (CH)

(72) Inventor: Jean-Camil Pitteloud, Vex (CH)

(21) Appl. No.: 15/509,246

(22) PCT Filed: Sep. 9, 2014
(86) PCT No.: PCT/EP2014/069196

§ 371 Date: Mar. 7, 2017

(51) Int. Cl. B29C 45/77; B29C 45/26; B29C 45/73; B29C 45/37; B29C 45/40

(52) U.S. Cl. CPC B29C 45/77; B29C 45/376; B29C 45/4005; B29C 45/73; B29C 45/2606; B29C 2045/0094

(57) ABSTRACT

A method and device for injection moulding micro-components, including an injection moulding machine having a mould carrier, which supports a removable mould in which at least one mould cavity is provided; and a counter mould, which is arranged so as to be closed against the mould in such a way as to apply a centering force as well as moulding pressure to the mould when the counter mould is closed against the mould.

### FIELD OF THE INVENTION

The present invention relates to an injection device (for moulding micro-components) constituted of an injection press in which a mould carrier is placed supporting a removable mould in which at least one mould cavity is provided for moulding, a counter mould arranged for exerting a moulding pressure on the mould. It also relates to a corresponding moulding method.

### STATE OF THE ART

Patent application EP0272138 describes a method for moulding plastic initiated by injecting molten resin into a mould under high pressure. The two parts of the mobile mould, movable relative to one another, are placed on four clamping bars fastened at the four corners of the mould. These bars have elastic elongation characteristics of a length delta L, in order to compensate a possible parallelism defect between the two adjacent faces of the mould. Due to the fact that the mould must be placed at the center of the four bars, the arrangement can be used only for a small number of parts to be moulded. Furthermore, the configuration with four bars that have to be mounted in a strictly parallel manner requires a very high precision, which makes the device complex and expensive to implement.

Document U.S. Pat. No. 7,763,191 describes a method and a device for performing an injection-compression operation of the stamping type. The device comprises a mould enclosing a spacing column in two parts. The device is designed for producing a slight axial compression during a high-pressure injection. Injection-compression moulding has the advantages of a lower compaction pressure, a homogeneous quality of the parts, a lower residual stress and a great dimensional accuracy as compared with classical injection moulding, and it is well adapted for manufacturing extremely thin parts or parts having a complex shape, for which classical injection moulding cannot meet the quality requirements or requires a very high tightening tonnage. However, the described solution involves the method being controlled by means of injection stages with reiterated moulding cycles carried out while performing adjustments with calculations between each cycle until the cavity's force converges with the tightening force, in order to achieve the correct thickness of the part to be moulded.

FR1414485 describes in a general manner the moulding of thermoplastic resins and more particularly a method for quick pressure moulding of different thermoplastic resins from a viscous mass to obtain articles having relatively thin shapes or whose thickness can vary considerably, without deformation. The solution described involves introducing into the mould's cavity a measured quantity of heated material depending on the cavity volume.

A micro-component moulding device is further known in which a mould designed for moulding a plurality of parts is lodged between a mould carrier and a counter mould, wherein the counter mould is traversed by as many injection nozzles as there are parts to be injected. This type of device yields good results, with a parts quality that is satisfactory when the mould comprises a limited number of cavities, for example a single, double or quadruple cavity. However, as soon as the number of cavities is increased, the quality of the parts produced becomes random, causing unacceptably high levels of parts having to be rejected.

To overcome these different drawbacks, the invention provides different technical means.

### BRIEF SUMMARY OF THE INVENTION

To begin with, a first object of the invention consists in providing a moulding device and method free from the aforementioned drawbacks.

Another object of the invention consists in providing a device and method for moulding micro-components enabling a high number of parts to be produced whilst maintaining a level of quality that complies with the often very strict requirements of micro-components designed for high precision mechanisms such as optical elements or parts for watch movements.

Yet another object of the invention consists in providing a moulding device and method allowing parts of very small dimensions and very low tolerances to be produced with a high degree of reliability and at an advantageous cost.

To this effect, the invention provides an injection device (for the moulding of micro-components) consisting of an injection press comprising: a mould carrier, supporting a removable mould in which at least one mould cavity for moulding is provided; and a counter mould, arranged so as to be closed against the mould in such a way as to apply a moulding pressure on the mould when the counter mould is closed against the mould, during a moulding operation by injection of material in the moulding cavities of the mould; wherein the device furthermore comprises a level compensation device adapted to deform under the influence of a force applied in an uneven manner on the mould's surface when the pressure is applied by the counter mould, so as to ensure a roughly uniform distribution of the pressure on the mould's surface.

Thanks to this architecture, the device according to the invention makes it possible to carry out large batches of mouldings with lots comprising several parts, such as for example 8, 12, 16, 24, 32 parts or even more, depending on the profiles and dimensions.

In one embodiment, the level compensation device comprises a bearing area abutting against the mould carrier and an elastic area comprising an elastically deformable zone so as to deform under the influence of an applied force.

The level compensation device is advantageously constituted of a single piece, thus making its integration in pre-existing moulding facilities easier, at reasonable costs.

Also advantageously, the elastically deformable zone is dimensioned so as to support at least approx. 10 to 20% beyond an injection force during the application of the pressure by the counter mould and of the injection of material into the moulding cavities of the mould.

The invention also provides a part moulding method by injection of material into a mould provided with a plurality of mould cavities of parts to be moulded comprising the steps consisting of:

positioning a mould provided with a plurality of mould cavities against a mould carrier;

closing the mould by applying a counter mould against the open portion of the mould cavities;

exerting a pressure against the mould, wherein said pressure is at least partly retransmitted at the level of a level compensation device; and

correcting any potential unbalance in the alignment of the mould and/or of the pressure applied on the surface of the mould by deformation of the level compensation device as a reaction to the unbalance.

Advantageously, after a mould opening phase, the parts extractor exerts a force to expulse the moulded parts out of their respective mould cavity.

### BRIEF DESCRIPTION OF THE FIGURES

All the details of embodiments are given in the description that follows, completed by the FIGS. 1 to 4, presented only by way of non limiting examples, and wherein:

FIG. 1a shows an elevation view of an example of moulding device according to the invention, in closed position;

FIG. 1b shows an elevation view of the example of FIG. 1a, with the mould in open position;

FIG. 2 is a schematic representation in perspective of the moulding device of FIG. 1 with the mould in open position;

FIG. 3 is a schematic representation from the front of an embodiment of the mould; and

FIG. 4 shows a perspective view of a mould frame, according to one embodiment.

### EXAMPLE(S) OF EMBODIMENTS OF THE INVENTION

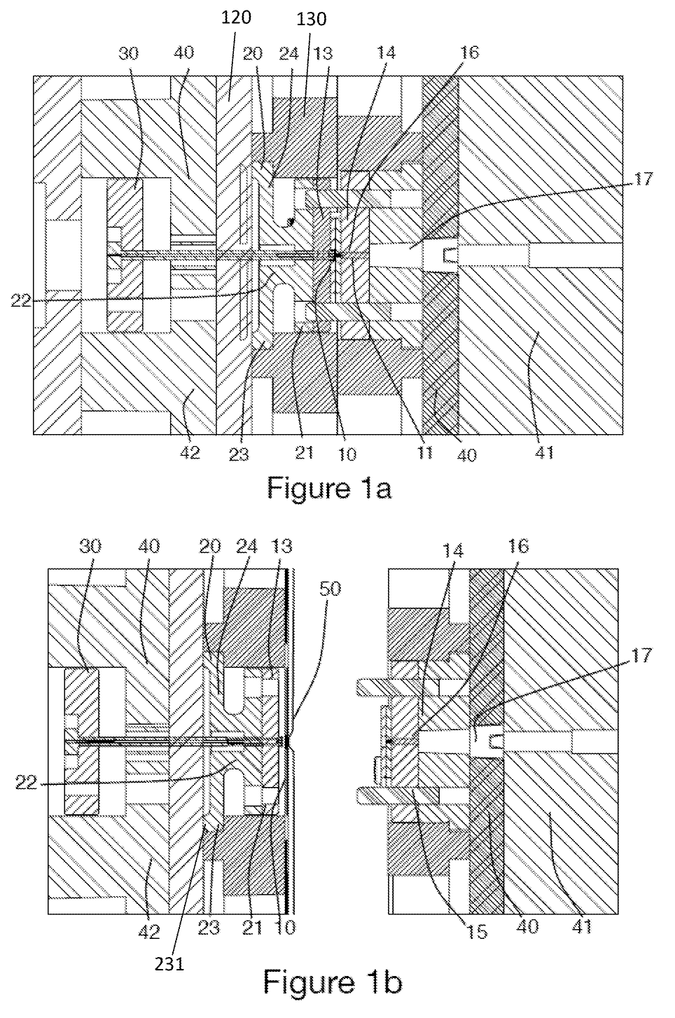

FIG. 1a illustrates an embodiment in which a mould 10 is constituted of a moulding insert in which a plurality of mould cavities 11 (or recesses or profiles) in the inverse image of the parts to be produced are formed. In the example illustrated, the insert comprises a single mould cavity allowing a toothed wheel with pinion to be moulded.

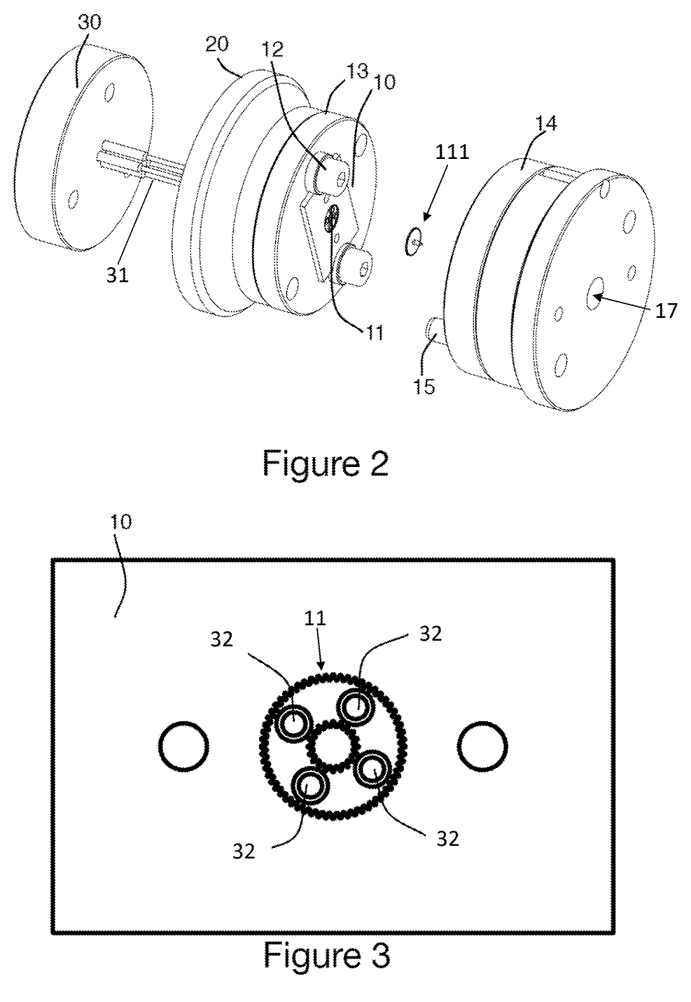

A mould support or mould carrier 13 in the form of a disc allows the mould 10 to be positioned and held on one of the faces of the mould carrier. In the example illustrated, two collar retaining bushings 12 (visible in FIG. 2) of the mould support are provided on each side of the latter to ensure it is held against the mould carrier 13. A counter mould 14 is provided opposite the mould 10 and the mould carrier 13. In the illustrated embodiment, the counter mould 14 is also in the shape of a disc, with one side being designed to interface with the mould 10, in order to form the last wall of the mould cavities 11.

As illustrated in FIG. 1a, a plurality of nozzles 16, fed by a feeding tunnel 17 with material to be injected, allow the required supply of injection material. Preferably, one nozzle is used per mould cavity.

As a variant, it is also possible to provide more than one nozzle per mould cavity or one nozzle for several mould cavities. FIG. 3 shows a schematic view from the front of an example of mould 10 comprising four mould cavities 11 representing a form of gearing. An example of a part (a wheel with a pinion) 111 manufactured by the injection device of the invention is shown in FIG. 3. It goes without saying that the shape of the mould cavities 11 can take any other shape corresponding to the part to be produced, for example a micro-lens.

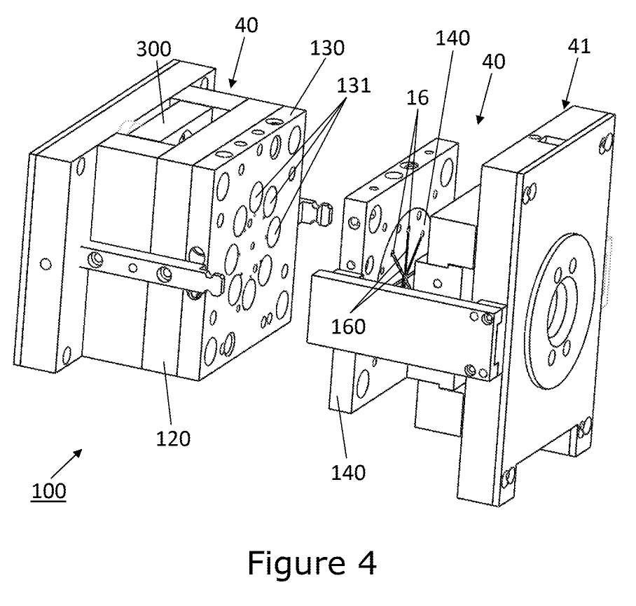

All the elements described here above are advantageously placed in a moulding enclosure 40 comprising a plurality of removable blocks, designed for lodging the moulding elements with a careful, accurate and reliable adjustment. FIG. 4 shows a perspective view of a mould frame 100 comprising a receiving plate 130 having a plurality of cavities 131 (eight in the example of FIG. 4). Each of the cavities 131 is configured for receiving a mould carrier 13 and to pre-position it relative to the counter mould 14. The mould frame 100 also comprises a counter mould plate 140 in which the counter mould 14 (or the counter moulds 14) is/are accommodated. The counter mould plate 140 can further comprise injection channels 160, which distribute the material to be injected through the feeding tunnel 17 to each one of the nozzles 16.

Since the device is intended for moulding micro-components, the dimensions of the different elements constituting it are provided with a high degree of precision. The same applies to the elements of the moulding enclosure 40 that must allow the mould 10, the mould cavities and the counter mould 14 to be positioned or centered in a very accurate manner. The centering accuracy of one part of the mould relative to the other is achieved through centering pins 15. The two bushings 12 held with screws are slightly longer than the thickness of the mould carrier 13. By leaving a radial play between the outer diameter of the collar retaining bushing 12 and the reaming of the mould carrier 13, the latter will be centered in XY by the two pins 15, which no longer requires a great alignment accuracy between the reamings of the cavities 131 of the receiving plate 130. The centering is independent of the number of mould cavities 11 since each is centered in an individual manner.

According to the invention, as can be seen in FIGS. 1a, 1b and 2, the mould carrier 13 is positioned against a level compensation device 20 whose particularities are described hereinafter.

The level compensation device 20 is an elastically deformable element which, thanks to its deformations, allows an optimal alignment of the mould elements to be maintained. The deformations of the level compensation device 20 are due to its architecture and to the materials that constitute it. In the embodiment illustrated in the figures, the level compensation device 20 comprises three areas: a bearing area 21 against the mould carrier 13; an elastic area 23 opposite the bearing area 21; and a joining area 22, forming a circumferential clearance between the two other areas 21 and 23.

The joining area 22 has a diameter that is less than the diameters of the two adjoining areas, thus forming a free zone between these two areas. The elastic area 23 furthermore comprises an elastically deformable zone 24 extending circumferentially on the elastic area 23. This zone is dimensioned so as to allow the level compensation device 20 to react to the variations in pressure on the surface of the mould 10, in order to compensate the latter by deforming around the elastically deformable area 24. After moulding, when the pressure is no longer exerted and the mould 10 is dismantled, the level compensation device 20 reverts to its initial shape thanks to its elastic properties. The elastically deformable area 24 of the level compensation device 20 is free and a rigid reinforced thickness 231 in the zone 23 rests on a support plate 120 comprised in the mould frame 100.

In one embodiment, the elastically deformable area 24 comprises a material such as Maraging steel. Maraging steel is advantageous for its stable elastic properties up to temperatures of 450° C. For example, a Maraging steel of the type X2NiCoMo18-9-5 to X3NiCoMoTi18-9-5, such as Maraging steel W720 produced by Bohler-Stahl, can be used. The elastically deformable zone 24 can also comprise another material having appropriate elastic properties depending on the load case associated with the part's geometry and the temperature associated with the type of polymer to be injected.

In the example of injection moulding device illustrated, the moulding enclosure 40 also accommodates an extractor 30 for moulded parts, which makes it easier to extract the moulded parts out of the mould after each of the moulding phases. In the example illustrated in FIGS. 2 and 3, the extractor 30 comprises four extraction rods 31 whose extremity 32 pushing the moulded parts is visible in FIG. 3. The extractor 30 can bear against an extractor pusher plate 300 of the mould frame 100.

An unmoulding conveyor 50 can advantageously be used in order to make easier the extraction of the moulded parts after moulding. A conveyor with anti-adhesive properties, such as for example a PTFE (Teflon)-based conveyor, is preferably used.

In the examples illustrated in FIGS. 1 and 2, the moulding enclosure 40 comprises a first half 41 comprising the counter mould 14 and the nozzle or nozzles 16, as well as a second half 42 comprising the mould 10, the mould carrier 13 and the extractor 30. When the two halves 41, 42 of the moulding enclosure 40 are closed, the device's components, in particular the mould 10 provided with its multiple mould cavities 11 for moulding, are put in place, aligned and adjusted accurately.

Once all the constituting elements are well arranged and fastened, the mould is closed again by placing the two enclosure halves 41, 42 one against the other, as shown in FIG. 1a.

During the closing of the enclosure 40, and thus the closing of the counter mould 14 against the mould 10, the counter mould 14 exerts a centering action with the mould 10 (as discussed here above) and creates a pressure force acting against the mould 10. In some cases, in particular if the mould cavities occupy a great surface, which is the case when a large number of micro-components are being moulded, the level compensation device 20 ensures the alignment, in particular the axial alignment, of the elements, in particular of the mould 10 with the counter mould 14. This alignment makes it possible to ensure a roughly uniform distribution of the pressure on the moulding surface, allowing parts to be produced in favorable conditions in order to achieve considerably high levels of production. Thus, the level compensation device 20 enables the adjacent sides of the mould carrier 13 and of the counter mould 14 to be held properly parallel to one another, so that the pressure exerted on the mould is uniform over the latter's entire surface. In the case of non-uniform pressure, for example following a poor alignment of the two aforementioned sides, the level compensation device 20 deforms so as to absorb the overpressure, thus re-establishing a uniform pressure over the whole surface of the mould.

Maintaining this uniform pressure over the whole of the mould's surface makes it possible to optimize the conditions in which the injection and moulding of the multiple parts are performed.

Calculating the pressure force exerted against the mould 10 can be achieved according to the formula of a beam encased at both extremities, of trapezoidal shape with the geometric development of the outer and inner diameters of the elastic zone for the sides, the difference in radius for the length, and the thickness of the elastically deformable zone 24 for the height of the beam. The sizing of the elastically deformable zone 24 is done so that the latter supports at least approx. 10 to 20% beyond an injection pressure times the surface of the part (i.e. at least approx. 10 to 20% beyond an injection force), during the application of the pressure by the counter mould 14 and the injection of material into the mould cavities 11 of the mould 10. The force necessary for compressing the elastically deformable zone 24, as well as the additional force (10 to 20% beyond an injection force) are taken by the closing force of the press. This dimensioning is done so that the system operates below the elastic limit of the material of the elastically deformable zone 24 (for example steel). Use of a CAM finite element calculation module can highlight the maximum stress zones in order to refine the geometry of the elastically deformable zone 24. Experience has shown that the simplified method described here above is sufficient for this application.

After moulding, the two halves of the moulding enclosure separate again. In the case of an over-moulding, the level compensation device 20 can deform and makes it possible to adapt the mould 10 to the thickness variations of the unmoulding conveyor 50, or of any other insert. In fact, the variations in thickness will be taken up by the flexibility of the elastically deformable zone 24. The unmoulding conveyor 50 makes it easier to unmould the parts produced.

An extractor 30 is advantageously used to exert a force towards the free side of the moulded parts, so as to extract them from the mould. Similarly, the use of an unmoulding conveyor 50 makes it easier to extract the moulded parts while diminishing the risks of sticking and producing an additional extraction force. Between each moulding, the conveyor 50 is moved so as to present for the following moulding a new material zone, neither deformed nor altered by the previously performed moulding.

The injection device described here allows several polymer materials to be injected. For example, the device lends itself well to the injection of technical materials such as polyoxymethylene (POM), poly(phenylene sulfide) (PPS), liquid crystal polymer (LPC), polyimide (PI), polyamide (PA, PA6), wherein these materials can be strongly loaded with glass fibers or mineral loads. However, various other materials suitable for injection can be used in the injection device of the invention with the level compensation device 20. One constraint can arise from materials used for mould cavities 11 that are subjected to abrasion and/or corrosion associated with the transformed polymer.

The injection device of the invention makes it possible to mould different types of micro-components, notably toothed wheels and pinions, casings, (watch) plates, optical components for a portable device such as a portable phone, micro-switches, inserts, etc.

Thanks to the inventive method, it is possible to obtain clearly higher levels of productivity since the number of mould cavities can be considerably increased. Furthermore, in the example illustrated, it was possible to increase the number of mould cavities from four to eight or sixteen and even thirty-two without any loss of quality.

### REFERENCE NUMBERS USED IN THE FIGURES

10 mould
11 mould cavity
12 collar retaining bushing
13 mould carrier
14 counter mould
16 nozzle
17 feeding tunnel
20 level compensation device
21 bearing area
22 joining area
23 elastic area
231 reinforced thickness, rigid bearing area
24 elastically deformable zone
30 extractor
31 extraction rod
32 extractor holes of the mould cavity
40 moulding enclosure
41 first half of the moulding enclosure
42 second half of the moulding enclosure
50 unmoulding conveyor
100 mould frame
111 part
120 support plate
130 receiving plate
131 cavity
140 counter mould plate
160 injection channels
300 extractor pusher plate

What is claimed is:

1. Injection device constituted of an injection press comprising:
a mould carrier, supporting a removable mould in which at least one mould cavity for moulding is provided;
a counter mould, arranged so as to be closed against the mould in such a way as to apply a centering action as well as a pressure on the mould when the counter mould is closed against the mould, during a moulding operation by injection of material in the moulding cavities of the mould;
a level compensation device comprising a bearing area abutting against the mould carrier, an elastic area opposite the bearing area, and a joining area forming a circumferential clearance between the bearing area and the elastic area;
the elastic area comprising an elastically deformable circumferential zone extending circumferentially on the elastic area;
the elastically deformable circumferential zone being adapted to deform under the influence of a force applied in an uneven manner on the surface of the mould when the pressure is applied by the counter mould, so as to ensure alignment of the mould with the mould carrier and ensure a substantially uniform distribution of the pressure on the surface of the mould.

2. (canceled)

3. (canceled)

4. Injection device according to claim 3,
wherein the bearing area, the joining area and the elastic area take the shape of discs arranged coaxially.

5. Injection device according to claim 4,
wherein the median joining area has a smaller diameter than that of the two areas.

6. Injection device according to claim 5,
wherein the elastically deformable zone is dimensioned so as to support at least approx. 10 to 20% beyond an injection force during the application of the pressure by the counter mould and of the injection of material into the moulding cavities of the mould.

7. (canceled)

8. Method for part moulding by injection of material using an injection device comprising a mould carrier supporting a removable mould in which a plurality of mould cavities for moulding is provided, a counter mould arranged so as to be closed against the mould in such a way as to apply a centering action as well as a pressure on the mould when the counter mould is closed against the mould, a level compensation device comprising a bearing area abutting against the mould carrier, an elastic area opposite the bearing area, and a joining area forming a circumferential clearance between the bearing area and the elastic area; the elastic area comprising an elastically deformable circumferential zone extending circumferentially on the elastic area, the elastically deformable circumferential zone being adapted to deform under the influence of a force applied in an uneven manner on the surface of the mould when the pressure is applied by the counter mould, so as to ensure alignment of the mould with the mould carrier and ensure a substantially uniform distribution of the pressure on the surface of the mould; the method comprising the steps of:
positioning the mould provided with a plurality of mould cavities against the mould carrier;
closing the mould by applying the counter mould against the open portion of the mould cavities;
exerting a pressure against the mould, wherein said pressure is at least partly retransmitted at the level of the level compensation device; and
correcting any potential unbalance in the alignment of the mould and/or of the pressure applied on the surface of the mould by deformation of the level compensation device as a reaction to the unbalance.

9. Moulding method according to claim 5, further comprising the steps of:
injecting material into the mould cavities via nozzles provided at the level of the counter mould;
maintaining the mould closed and under pressure during the period of curing of the material injected into the mould; and
opening the mould and removing the parts obtained.

10. Moulding method according to claim 5,
wherein before a mould closing phase, an unmoulding conveyor is positioned between the mould cavities and the mould carrier.

11. Moulding method according to claim 7,
wherein after a mould opening phase, the unmoulding conveyor is tensioned in order to make easier the extraction of the moulded parts out of the mould cavities.

12. Moulding method according to one of the claims 5,
wherein after a mould opening phase, the parts extractor exerts a force to expulse the moulded parts out of their respective mould cavity.
